(19) United States
(12) Patent Application Publication
(10) Pub. No.: US 2005/0190019 A1
(43) Pub. Date: Sep. 1, 2005

(54) Low-loss transmission line structure

(76) Inventor: Carsten Metz, Township of Chatham, NJ (US)

Correspondence Address: Lucent Technologies Inc., Docket Administrator (Room 3J-219), 101 Crawfords Corner Road, Holmdel, NJ, 07733-3030, US

(21) Appl. No.: 10/788,826

(22) Filed: Feb. 27, 2004

(51) Int. Cl. H01P 3/08

(52) U.S. Cl. 333/238

(57) ABSTRACT

A microstrip transmission line structure is disclosed wherein a transmission element is attached to a substrate in a way such that the element is suspended above the substrate separated by a predetermined distance from a ground plane. In one embodiment, the transmission element is supported by a plurality of support legs that are disposed in a way such that the transmission element is suspended above the substrate. In another embodiment, a portion of the substrate is removed in a way such that, when the transmission element is disposed on the substrate, the line is separated from the ground plane by a predetermined distance.

### FIELD OF THE INVENTION

The present invention relates to high frequency electronic circuit boards and, more particularly, to low-loss transmission lines in such circuit boards.

### BACKGROUND OF THE INVENTION

Efficient transmission of broadband radio frequency (RF) signals is essential to meet the demanding requirements of high-speed networking systems. Individual circuit elements, such as 50 Ohm impedance microstrip transmission lines, which are very well known in the art, must be carefully designed to minimize signal losses. The importance of minimizing these losses is increasing as such systems operate at higher frequencies over longer distances. Various well-known transmission lines, such as the aforementioned microstrip transmission lines, have been used to carry signals on multilayered circuit boards for relatively low frequency applications, such as at or below 40 GHz.

However, while transmission lines of this type provide a high-quality signal path at such frequencies, they are limited in their usefulness at higher frequencies, such as at or above 70 GHz. Specifically, as frequencies rise to ≧70 GHz, signal attenuation for a given traditionally-designed transmission line length increases significantly and, accordingly, the received signal strength at a signal's destination is significantly reduced. Thus, traditional microstrip transmission lines are inadequate for use at such high frequencies.

### SUMMARY OF THE INVENTION

The present inventor has realized that the aforementioned RF signal loss at higher frequencies is caused to a large extent by the electromagnetic field in the dielectric substrate underlying the transmission line that results as a signal propagates along the transmission line. At higher frequencies, the degree of substrate interaction per unit length increases, resulting in the aforementioned weak signal at the intended destination of the signal.

Therefore, the present inventor has invented a transmission line structure that essentially solves this problem. In accordance with one embodiment of the present invention, a transmission element is connected to a substrate in a way such that the transmission element is suspended above the ground plane and separated by a predetermined distance from that plane. In one embodiment, the transmission line comprises a plurality of support legs that are disposed in a way such that the transmission line is suspended above the substrate. In another embodiment, a portion of the substrate is removed in a way such that, when the transmission line is disposed on the substrate, the line is separated from the substrate by a predetermined distance.

### BRIEF DESCRIPTION OF THE DRAWING

FIG. 1 shows an illustrative prior art transmission line disposed on a substrate;

FIG. 2 an illustrative transmission line suspended above a substrate in accordance with the principles of a first embodiment of the present invention;

FIG. 3 shows an illustrative transmission line suspended above a substrate in accordance with the principles of a second embodiment of the present invention;

FIGS. 4A and 4B show how a portion of a substrate can be removed in order to create a separation distance between the substrate and the transmission line;

FIG. 5 shows an illustrative graph illustrating how the insertion loss of a signal is greatly reduced in accordance with the principles of the present invention.

### DETAILED DESCRIPTION OF THE INVENTION

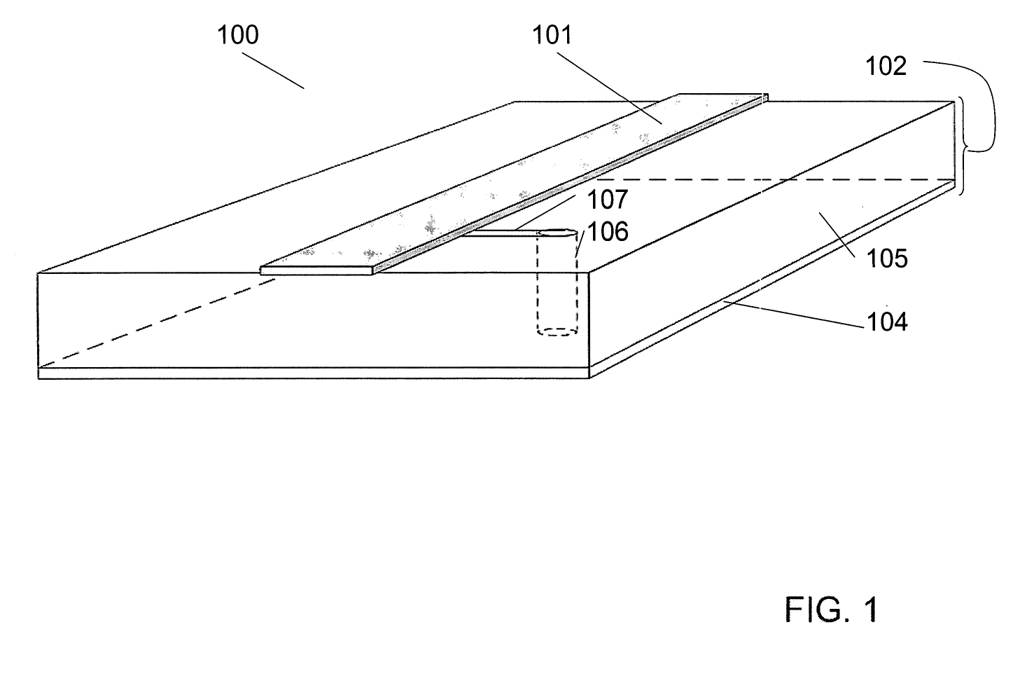

FIG. 1 shows an illustrative prior art transmission line structure 100 having substrate 102 that is, illustratively, a multi-layered circuit board having a dielectric layer 105 and a metallized ground plane layer 104. The metallized layer 104 is, illustratively, a thin layer of copper material. The dielectric layer 105 could be for example, a layer of silicon dioxide material. Transmission line 101 is, illustratively, connected to ground plane 104 by lead 107 connected to via 106. Vias such as via 106 are well known in the art and are, illustratively, metallized holes through the dielectric layer 105 that provide a conducting electrical path to ground layer 104.

While the illustrative transmission line of FIG. 1 is useful as a path for routing RF signals across circuit boards in many applications, problems result as the frequency of the RF signal rises. In particular, as the frequency of the signal increases, that signal is more easily attenuated by the well-known electromagnetic field that is present within the dielectric layer 105 of substrate 102. This attenuation is often referred to as dielectric attenuation or dielectric loss. The result of such dielectric loss is that as a relatively high frequency signal, such as an illustrative signal at or above 60 GHz, travels along the transmission line 101, it becomes significantly attenuated over a relatively short distance of travel relative to lower frequency signals, such as signals at or below, for example, 20 GHz. With the advent of systems relying on frequencies near and above 70 GHz, this dielectric loss becomes extremely problematic.

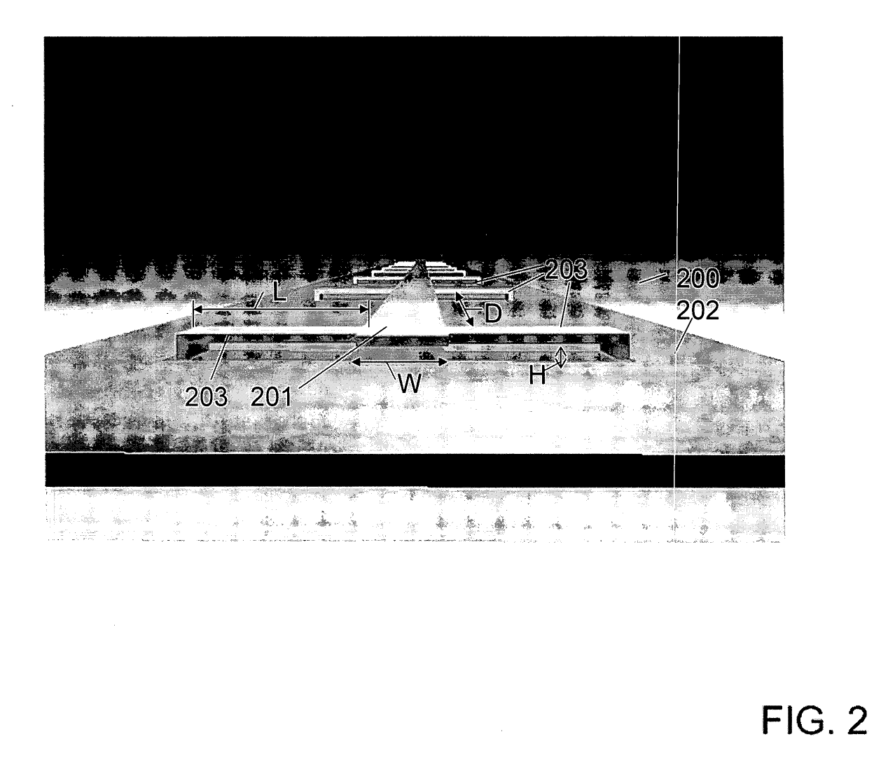

FIG. 2 shows one illustrative embodiment of a transmission line structure 200 in accordance with the principles of the present invention whereby the aforementioned dielectric signal loss is reduced or substantially eliminated. Specifically, FIG. 2 shows an illustrative transmission line 201 that is physically suspended above substrate 202 which is, illustratively, a metallized layer functioning as an electrical ground for transmission line 201. Transmission line 201 is also referred to herein interchangeably as a transmission element. One skilled in the art will recognize that substrate 202 may be, for example, a layer of gold, copper, aluminum, or another electrically conducting material suitable for use as a ground plane. Support elements 203, here illustratively bent support arms, are attached to both the transmission line and the substrate and function to both support the transmission line above the ground substrate 202 as well as, illustratively, to electrically connect the transmission line to that substrate. Once again, support arms 203 may be, illustratively, manufactured from an electrically conducting material such as the aforementioned gold, copper or aluminum or any other electrically conducting material. One skilled in the art will recognize that other materials, such as plastic may be used to support the transmission element. Support arms 203 have length L and height H and are spaced a distance D from each other. One skilled in the art will recognize that L, D and H can be selected to produce a desired electrical property of transmission element 201, such as the impedance of the transmission line. For example, if the line width W is selected as 1.08 mm, the length L of the support arms is selected as 3.01 mm, the height H is selected as 250 micrometers, and the support arms are separated by 4 mm from each other, transmission line 201 will illustratively have approximately a 50 Ohm impedance, which is desirable in a number of applications. Other dimensions may be selected to produce a variety of desirable transmission line impedances. The transmission line structure 200 of FIG. 2 substantially reduces the signal attenuation of a high-frequency RF signal propagating along transmission line 201. This reduction is the result of separating the transmission line from the substrate and, accordingly, reducing the exposure of the propagating signal to any electromagnetic field present in the substrate.

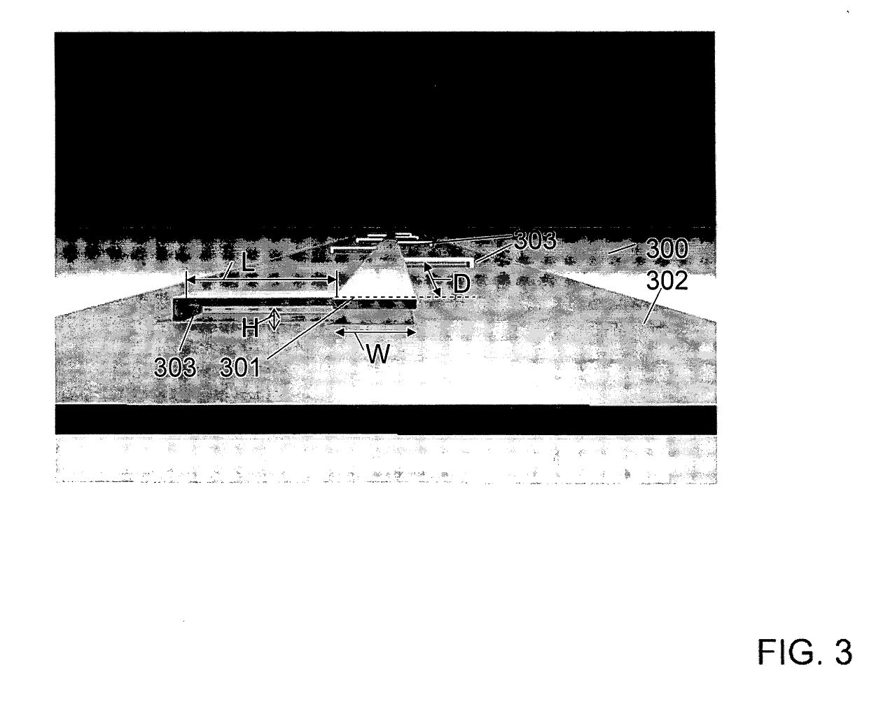

FIG. 3 shows another embodiment of a transmission line structure 300 in accordance with the principles of the present invention whereby, similar to the embodiment of FIG. 2, support arms 303 support transmission line 301 so that the transmission line is suspended above the substrate 302. However, unlike in the embodiment of FIG. 2, the support arms 303 of FIG. 3 alternate along the length of the transmission line 301. Such an arrangement of support arms 303 is advantageous in that approximately half of the number of support arms is required as compared to the embodiment of FIG. 2. Accordingly, manufacturing costs may be reduced since fewer arms need to be produced and fewer connections between the arms and the underlying substrate need to be made. Once again, one skilled in the art will recognize and fully appreciate how to tune the transmission line of FIG. 3 (e.g., to achieve a specific electrical property, such as line impedance) by adjusting the height H and width W of the transmission line 301 as well as the spacing D between and length L of the support arms.

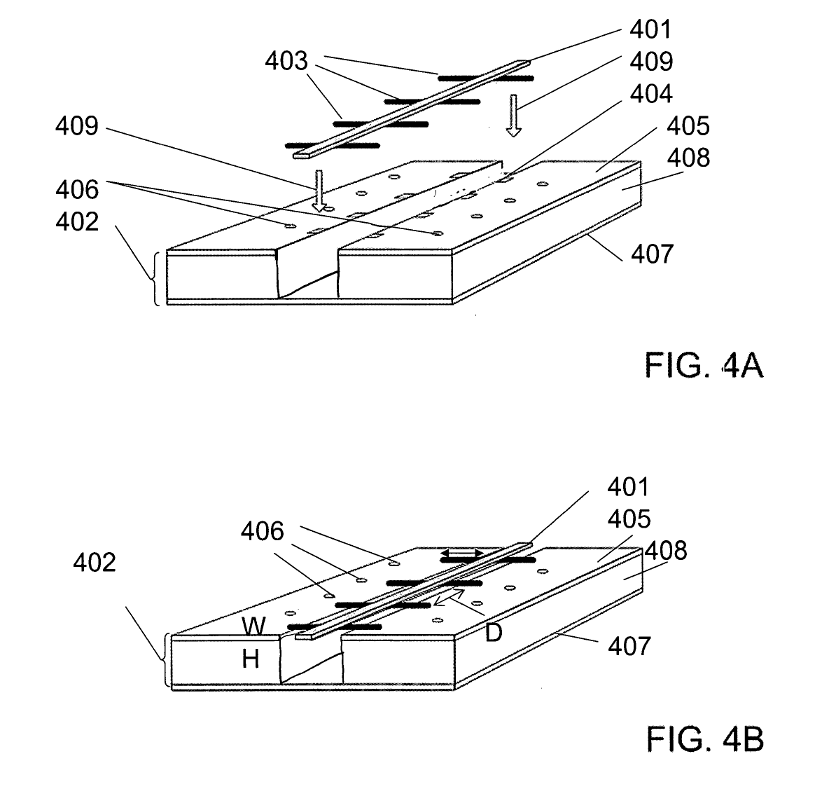

FIGS. 4A and 4B illustrate yet another embodiment in accordance with the principles of the present invention whereby, instead of raising the transmission line above the substrate, a portion of the substrate itself is removed in order to provide a separation distance between the substrate and the transmission line 401. Referring to FIG. 4A, substrate 402 has, for example, metallized top layer 405, dielectric layer 408 and metallized ground layer 407. Illustrative vias 406 function to connect the top metallized layer to the ground layer 407 and, accordingly, act to electrically connect the transmission line 401 to layer 407. One skilled in the art will recognize that such electrical connection of the transmission line to the ground layer may or may not be required or desired to achieve the desired transmission properties of the transmission line structure. Once again, transmission line 401 and layers 405 and 407 are, illustratively, manufactured from aluminum, copper or gold. Dielectric layer 408 is, illustratively, manufactured from silicon dioxide or any other well-known material suitable for such a use, such as, for example, a soft substrate like the Ro3003 substrate manufactured by Rogers Corporation.

Transmission line 401 is attached to support arms 403 that are connected to contact areas 404 of metallized top layer 405, as is illustratively shown in FIG. 4B. Unlike in the embodiments of FIGS. 2 and 3, the support arms are simpler in design in that they are not bent at the ends, as depicted by illustrative support arms 203 in FIG. 2 and illustrative support arms 303 in FIG. 3. Instead, support arms 403 are, illustratively, straight and of a length L that permits the end of each support arm to be lowered in direction 409 and connected to one of the aforementioned contact areas 404. Such straight support arms are advantageous in that they are potentially less costly to manufacture than a transmission line structure such as that shown in FIG. 2 or 3. As described above, by selecting an appropriate height H, width W, length L and separation distance D, one skilled in the art will be readily able to tune the transmission characteristics (e.g., the impedance) of line 401 of FIGS. 4A and 4B.

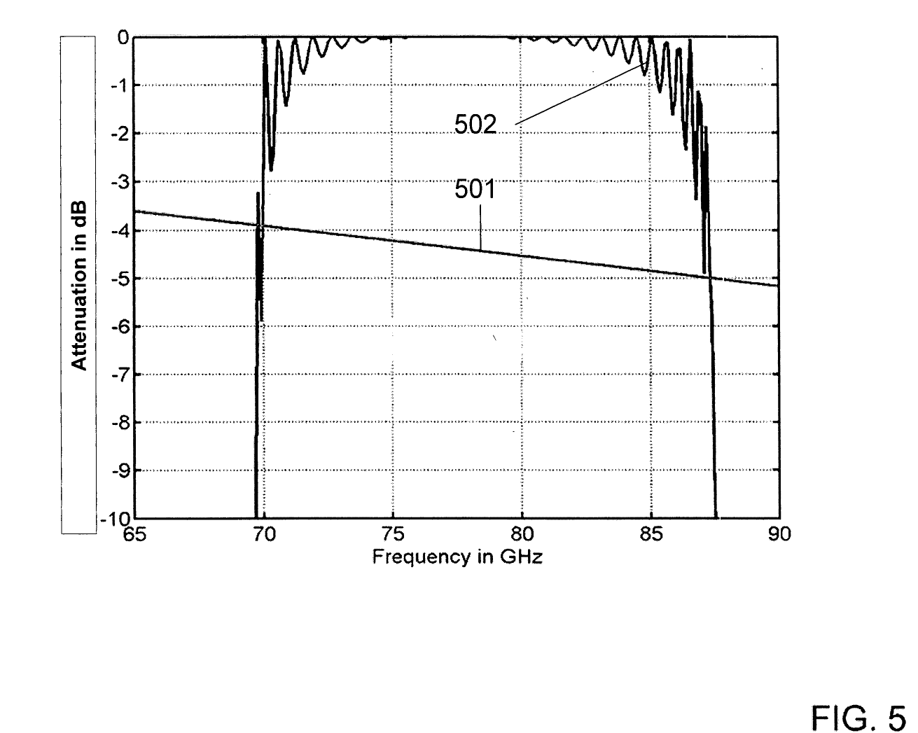

FIG. 5 shows an illustrative graph of the attenuation of a signal traveling across a transmission line of 124 mm in length versus the frequency of the signal. Plot line 501 represents, for example, the attenuation of a signal traveling across the transmission line of FIG. 1 where a line of width 605 micrometers is disposed on a low-loss dielectric substrate 250 micrometers above the ground plane where the dielectric constant is 3 and the dissipation factor is 0.0013. Plot line 502 represents, on the other hand, the attenuation of a signal traveling across the transmission line of FIG. 3. Specifically, plot line 502 represents a signal traveling across a 1087 micrometer wide transmission line on a substrate having a dielectric constant of 1. Similar to FIG. 3, the transmission line represented by plot 502 is supported at 250 micrometers above the ground plane by 31 supports spaced 4 mm apart. One skilled in the art will readily appreciate that many different values for the aforementioned design characteristics of the transmission line and supporting substrate can be used to achieve a transmission line structure having desirable functional characteristics.

Referring to the plot lines 501 and 502 in FIG. 5, the benefits of a transmission line supported above a substrate in accordance with the principles of the present invention are clear. Specifically, for high frequency applications, here approximately 70 GHz to approximately 85 GHz, the attenuation experienced by the signal traveling across the transmission line having the above specifications is greatly reduced. For signals throughout that relatively broad frequency band, the attenuation is much lower than that experienced by a traditional transmission line. For example, at approximately 75-80 GHz, the signal traveling across a traditional line is attenuated by 4.0 to 4.5 dB relative to the same signal traveling across a transmission line in accordance with the principles of the present invention.

The foregoing merely illustrates the principles of the invention. It will thus be appreciated that those skilled in the art will be able to devise various arrangements which, although not explicitly described or shown herein, embody the principles of the invention and are within its spirit and scope. Furthermore, all examples and conditional language recited herein are intended expressly to be only for pedagogical purposes to aid the reader in understanding the principles of the invention and are to be construed as being without limitation to such specifically recited examples and conditions. Moreover, all statements herein reciting aspects and embodiments of the invention, as well as specific examples thereof, are intended to encompass functional equivalents thereof.

1. A radio frequency transmission line structure comprising:
a conducting transmission element;
a substrate comprising at least a first ground plane for grounding said transmission element;
means for electrically connecting said transmission element to said at least a first ground plane; and
means for suspending said conducting transmission element a first distance away from said substrate in a way such that said transmission element is located at a second predetermined distance away from said ground plane.

2. The transmission line structure of claim 1 wherein said conducting transmission element is a microstrip transmission line adapted to carry a radio frequency signal.

3. The transmission line structure of claim 1 wherein said substrate further comprises a plurality of conducting layers separated by at least a first layer of dielectric material.

4. The transmission line structure of claim 1 wherein said means for electrically connecting comprises a plurality of conducting support elements electrically connected to said ground plane.

5. The transmission line structure of claim 1 wherein said means for suspending comprises said means for electrically connecting.

6. The transmission line structure of claim 1 wherein said means for suspending comprises a plurality of support elements attached to said transmission element.

7. A radio frequency transmission line structure comprising:
a dielectric substrate having at least a first ground plane;
a conducting transmission element;
a plurality of support elements for suspending said transmission element a predetermined distance away from said ground plane,
wherein said transmission element is not in contact with said substrate other than through said support elements.

8. The transmission line structure of claim 7 wherein said transmission element is in contact with said substrate only through said support elements.

9. The transmission line structure of claim 7 wherein said support elements are support arms adapted to suspend said transmission element above said substrate.

10. The transmission line structure of claim 7 wherein said support elements are support posts comprising a part of said substrate.

11. The transmission line structure of claim 7 wherein at least one of said support elements comprises an electrically conducting material.

12. The transmission line structure of claim 7 wherein at least a first characteristic of said support elements and at least a first characteristic of said transmission element are selected in a way such that at least a first electrical property of said transmission line structure is achieved.

13. The transmission line structure of claim 12 wherein said at least a first property of said transmission line structure comprises the impedance of said transmission line structure.

14. A radio frequency transmission line structure comprising:
a dielectric substrate having at least a first ground plane;
a conducting transmission element;
a plurality of support elements for suspending said transmission element a desired distance away from said ground plane,
wherein said transmission element is not substantially in direct contact with said substrate.

15. The transmission line structure of claim 8 wherein said transmission element is in contact with said substrate only through said support elements.

16. The transmission line structure of claim 8 wherein said support elements are support arms adapted to suspend said transmission element above said substrate.

17. The transmission line structure of claim 8 wherein said support elements are support posts comprising a part of said substrate.
